(19) United States
(12) Patent Application Publication
(10) Pub. No.: US 2025/0053461 A1
(43) Pub. Date: Feb. 13, 2025

(54) METHOD, APPARATUS, SYSTEM AND COMPUTER PROGRAM FOR FUNCTION NOTIFICATION OF FUNCTION ACCELERATOR CARD IN CLOUD SYSTEM

(71) Applicant: SAMSUNG SDS CO., LTD., Seoul (KR)

(72) Inventors: Beumjin CHO, Seoul (KR); Namsik HAM, Seoul (KR); Jisun CHAE, Seoul (KR); Yoonchan JHI, Seoul (KR); Jihoon CHO, Seoul (KR)

(73) Assignee: SAMSUNG SDS CO., LTD., Seoul (KR)

(21) Appl. No.: 18/652,450

(22) Filed: May 1, 2024

(30) Foreign Application Priority Data
Aug. 11, 2023 (KR) 10-2023-0105521

(51) Int. Cl. G06F 9/50

(52) U.S. Cl. CPC G06F 9/5083

(57) ABSTRACT

The present disclosure relates to a method, an apparatus, a system, and a computer program for function notification of a function accelerator card in a cloud system and, more particularly, to a method performed by a control server of a cloud system, an apparatus, a system, and a computer program, wherein the method includes: receiving, from a function accelerator card included in at least one unit task server of the cloud system, a list of acceleration functions that are capable of being performed by the function accelerator card; and assigning a first task to the function accelerator card in consideration of the acceleration function list. According to the present disclosure, a list of acceleration functions of a functional acceleration card included in a unit task server of a cloud system may be notified to a control server, thereby enabling efficient distribution of the workload and improving the overall performance of the cloud system.

### CROSS-REFERENCE TO RELATED APPLICATION(S)

This application is based on and claims priority under 35 U.S.C. 119 to Korean Patent Application No. 10-2023-0105521, filed on Aug. 11, 2023, in the Korean Intellectual Property Office, the disclosure of which is herein incorporated by reference in its entirety.

### BACKGROUND OF THE INVENTION

### 1. Field of the invention

The present disclosure relates to a method, an apparatus, a system, and a computer program for function notification of a function accelerator card in a cloud system and, more particularly, to a method, an apparatus, a system, and a computer program for function notification of a function accelerator card in a cloud system, wherein a list of acceleration functions of a function accelerator card (FAC) in a unit task server of the cloud system can be notified to a control server, thereby enabling efficient distribution of a task load and improving the overall performance of the cloud system.

### 2. Description of the Prior Art

Recently, cloud-related technologies that provide services based on wired and wireless communication networks have been spreading widely. More specifically, cloud services are network-based services that provide systems and application software that run using a large number of unit task servers installed in data centers, etc.

Furthermore, in recent years, a cloud service provider (CSPs) has been attempting to equip each unit task server in a data center with function accelerator cards (FACs), which can accelerate various functions such as a network function accelerator, a security function accelerator, and a storage function accelerator, thereby enhancing the processing performance of each unit task server and, consequently, improving the efficiency of a cloud system.

However, in the conventional cloud systems as described above, each unit task server processes a task load assigned thereto in a way which allocate a part of the task load to equipped function accelerator cards, thus limiting the efficient utilization of various acceleration functions of each feature acceleration card included in each unit task server.

Furthermore, in the conventional cloud systems, there was also a problem in which in order to assign a task load to each function accelerator card, the task load was redistributed to each function accelerator card through each unit task server, thereby reducing the task efficiency of the unit wok server and the function accelerator card.

Accordingly, there is a need for a method that can efficiently use multiple acceleration functions of each function accelerator card in a cloud system and, furthermore, solve the problem in which, in order to assign a task to each function accelerator card, the task was redistributed to each function accelerator card through each unit task server, thereby reducing the task efficiency of the unit task server and the function accelerator card. However, an appropriate solution has not yet been proposed.

### SUMMARY OF THE INVENTION

The present disclosure has been invented to solve the problems of the prior art as described above, and an aspect of the present disclosure is to provide a method, an apparatus, a system, and a computer program for function notification of function accelerator cards in a cloud system, wherein the cloud system can efficiently use multiple acceleration functions of each function accelerator card.

Another aspect of the present disclosure is to provide a method, an apparatus, a system, and a computer program for function notification of function accelerator cards in a cloud system, which can solve the problem in which, in order to assign a task load to each function accelerator card, the task load is redistributed to each function accelerator card through each unit task server, thereby reducing the task efficiency of the unit task server and the function accelerator card.

Technical tasks to be achieved in the present disclosure are not limited to the above-described technical tasks. Other technical tasks, which have not been described above, may be clearly understood by those skilled in the art, to which the disclosure belongs, through the description of the specification.

A first aspect of the present disclosure provides a method performed by a control server of a cloud system. The method may include: receiving, from a function accelerator card included in at least one unit task server of the cloud system, a list of acceleration functions that are capable of being performed by the function accelerator card; and assigning a first task to the function accelerator card in consideration of the acceleration function list.

A second aspect of the present disclosure provides a control server for a cloud system, which includes: a processor; and a memory. The memory may include instructions which, when executed by the processor, cause the server to implement specific operations. The specific operations may include: receiving, from a function accelerator card included in at least one unit task server of the cloud system, a list of acceleration functions that are capable of being performed by the function accelerator card; and assigning a first task to the function accelerator card in consideration of the acceleration function list.

A third aspect of the present disclosure provides a computer-readable storage medium storing instructions which, when executed by a processor, cause a control server of a cloud system including the processor to implement specific operations. The specific operations may include: receiving, from a function accelerator card included in at least one unit task server of the cloud system, a list of acceleration functions that are capable of being performed by the function accelerator card; and assigning a first task to the function accelerator card in consideration of the acceleration function list.

The function accelerator card and the unit task server may each be configured as separate task nodes in the cloud system.

The function accelerator card may be configured to be assigned second identification information distinct from first identification information of the unit task server, and the control server may receive the acceleration function list from the function accelerator card by using the second identification information.

The acceleration function list may be generated using an agent installed and driven in the function accelerator card, and is transmitted to the control server.

The agent may be configured to generate available resource information regarding the status of available resources of the function accelerator card and transmit the available resource information to the control server.

The agent may be configured to generate state information regarding an operation state of the function accelerator card at predetermined intervals and transmit the state information to the control server.

The control server may be configured to update the state of the function accelerator card based on the state information periodically transmitted from the agent, and to assign a task to the function accelerator card in consideration of the state of the function accelerator card.

The control server may be configured to produce, based on predetermined criteria, a second task corresponding to the first task and assign the second task to the unit task server including the function accelerator card.

The control server may be configured to produce the second task based on network traffic generated between the first task and the second task and assign the second task to the unit task server.

A part of the first task assigned to the function accelerator card may be migrated to and processed by the unit task server including the function accelerator card.

In case that performance of the first task does not meet predetermined target performance, a part of the first task may be migrated to and processed by the unit task server.

Accordingly, a method, an apparatus, a system, and a computer program for function notification of a function accelerator cards included in a cloud system, according to an embodiment of the present disclosure, enables efficient use of multiple acceleration functions of each function accelerator card included in a unit task server of the cloud system.

Furthermore, a method, an apparatus, a system, and a computer program for function notification of a function accelerator cards included in a cloud system, according to an embodiment of the present disclosure, may solve the problem in which, in order to assig a task load to each function accelerator card, the task load is redistributed to each function accelerator card through each unit task server, thereby reducing the task efficiency of the unit task server and the function accelerator card.

The effects which may be obtained from the present disclosure are not limited to the effects mentioned above, and other effects not mentioned will be clearly understood by those skilled in the art, to which the present disclosure belongs, from the description in the specification.

### BRIEF DESCRIPTION OF THE DRAWINGS

The accompanying drawings, which are incorporated as part of the detailed description to facilitate the understanding of the present disclosure, provide embodiments of the present disclosure and, together with the detailed description, illustrate the technical ideas of the present disclosure.

FIG. 1 illustrates the configuration and operation of a cloud system according to an embodiment of the present disclosure;

FIG. 2 is a flowchart illustrating task assignment in a cloud system according to an embodiment of the present disclosure;

FIGS. 3 and 4 illustrate notification of an acceleration function list of a function accelerator card in a cloud system according to an embodiment of the present disclosure;

FIG. 5 is a flowchart illustrating notification of an acceleration function list of a function accelerator card in a cloud system according to an embodiment of the present disclosure;

FIG. 6 illustrates updating the operation state of a function accelerator card in a cloud system according to an embodiment of the present disclosure;

FIG. 7 is a flowchart illustrating updating the operation state of a function accelerator card in a cloud system according to an embodiment of the present disclosure;

FIG. 8 illustrates task allocation from a function accelerator card to a unit task server according to an embodiment of the present disclosure; and

FIG. 9 illustrates the configuration of a control server in a cloud system according to an embodiment of the present disclosure.

### DETAILED DESCRIPTION OF THE EXEMPLARY EMBODIMENTS

Hereinafter, embodiments disclosed in the specification will be described in detail with reference to the accompanying drawings. The aspects, specific advantages, and novel features of the present disclosure will become apparent from the following detailed description and preferred embodiments related to the accompanying drawings.

The terms and words used in the specification and claims have been properly defined by the inventor to best describe the inventor's invention, should be construed in meanings and concepts consistent with the technical idea of the present disclosure, and are intended merely to describe embodiments and should not be construed as limiting the present disclosure.

In assigning reference numerals to components, identical or similar components are assigned the same reference numerals regardless of the reference numerals, and redundant descriptions thereof will be omitted. The suffixes “module” and “unit” for elements used in the following description may be assigned or used interchangeably for ease of description, are not intended to have distinct meanings or roles, and may refer to either software or hardware elements.

In describing the elements of the present disclosure, unless otherwise mentioned, singular forms of the element should be understood to include plural forms as well. Furthermore, the terms “first”, “second”, “third”, and the like are used to distinguish one element from another element, but the components are not limited by such terms. Furthermore, when it is mentioned that an element is connected to another element, it is understood that another element may be connected between the element and the other element.

Furthermore, in the following description of embodiments disclosed in the specification, a detailed description of known relevant art will be omitted when it is determined that the detailed description may obscure the subject matter of the embodiments disclosed in the specification. Furthermore, the accompanying drawings are intended only to facilitate understanding of the embodiments disclosed in the specification, and it is to be understood that the technical idea disclosed in the specification is not limited by the accompanying drawings, and thus the present disclosure should be construed to cover all modifications, equivalents, or substitutions that are within the scope of the idea and technology of the present disclosure.

Hereinafter, exemplary embodiments of a method, an apparatus, a system, and a computer program for function notification of function accelerator cards included in a cloud system according to the present disclosure will be described in detail with reference to the accompanying drawings.

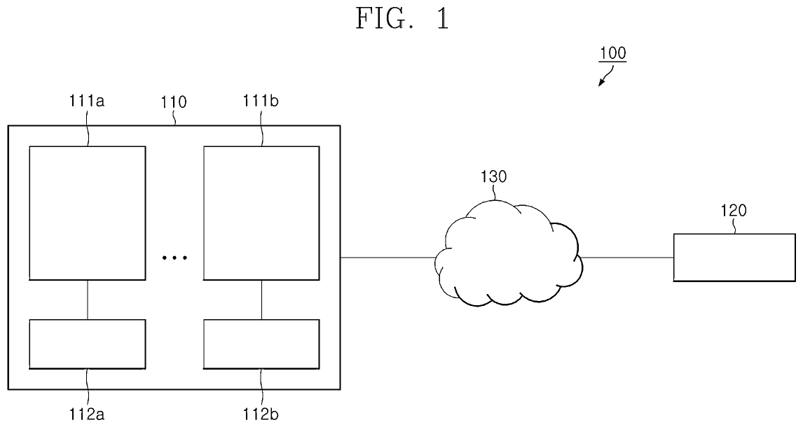

FIG. 1 illustrates the configuration and operation of a cloud system 100 according to an embodiment of the present disclosure. As illustrated in FIG. 1, the cloud system 100 according to an embodiment of the present disclosure may include a task server 110 which includes one or more unit task servers 111a and 111b including one or more function accelerator cards 112a and 112b, and a control server 120 configured to assign tasks to the one or more unit task servers 111a and 111b and the one or more function accelerator cards 112a and 112b and control the tasks.

In the task server 110, it is not required that all of the one or more unit task servers 111a and 111b be equipped with one or more function accelerator cards 112a and 112b, and some of the unit task servers 111a and 111b may be equipped with a typical network interface card, or the like.

Furthermore, in FIG. 1, the cloud system 100 is illustrated as an example of a cloud service provided by a cloud service provider (CSP), but the present disclosure is not necessarily limited thereto and may include a cloud system 100 that operates in various environments such as an on-premise environment.

Furthermore, the present disclosure describes an embodiment in which the cloud system 100 is configured based on Kubernetes. However, the present disclosure is not necessarily limited thereto.

Furthermore, the control server 120 may be implemented using one or more physical servers, but the present disclosure is not necessarily limited thereto, and the control server 120 may also be configured using personal computing devices such as desktop computers, laptops, tablets, or smartphones, or may be implemented in various other forms such as dedicated devices.

Furthermore, the task server 110 including the one or more unit task servers 110a and 110b may be implemented in the form of a server rack, but the present disclosure is not necessarily limited thereto, and the task server 110 may be implemented in various other forms.

Furthermore, the one or more function accelerator cards 112a and 112b may be implemented in the form of cards installed in slot or the like of the unit task servers 110a and 110b, but the present disclosure is not necessarily limited thereto, and the function accelerator cards 112a and 112b may be implemented in various other forms.

The one or more function accelerator cards 112a and 112b may be equipped with a central processing unit (CPU) or the like capable of computation or information processing, and thus may be operated independently of the unit task servers 110a and 110b, and furthermore, may be configured as task nodes separate from the unit task servers 110a and 110b in the cloud system 100 to receive and process tasks independently.

Furthermore, each of the one or more function accelerator cards 112a and 112b may be a smart network interface card (a smartNIC), a data processing unit (DPU), or an intelligence processing unit (IPU), but the present disclosure is not necessarily limited thereto.

Furthermore, the one or more function accelerator cards (FACs) 112a and 112b may include acceleration function modules, which can accelerate various functions, such as a network function accelerator, a security function accelerator, and a storage function accelerator.

Furthermore, in FIG. 1, a wired network and a wireless network may be used as a network 130 connecting the task server 110 to the control server 120. Specifically, the network 130 may include various communication networks such as a local area network (LAN), a metropolitan area network (MAN), and a wide area network (WAN). In addition, the network 130 may include the known World Wide Web (WWW). Furthermore, the network 130 may be implemented using a data bus or the like configured to transmit and receive data or the like.

Furthermore, in the present disclosure, the task server 110 and the control server 120 in the cloud system 100 are not necessarily required to transmit and receive data over the network 130, and may be implemented in various forms, such as a form in which some or all components of the control server 120 being integrated with the task server 110.

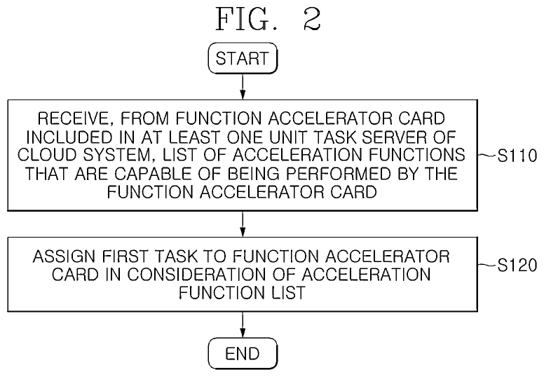

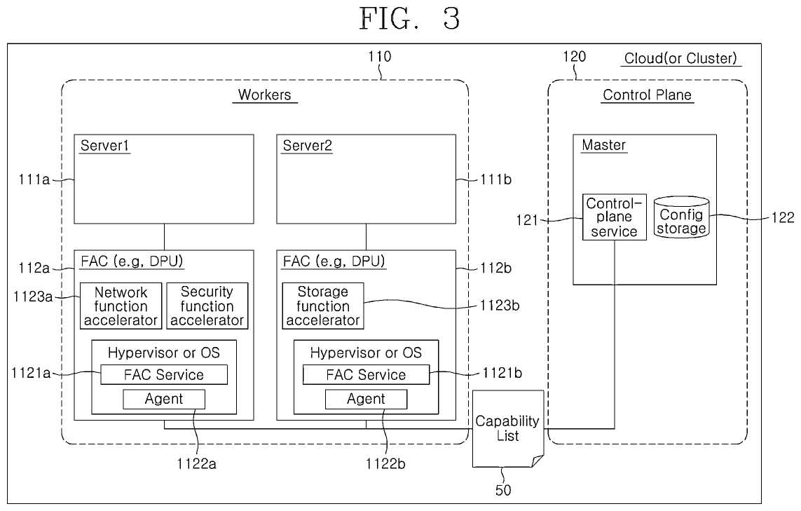

Furthermore, FIG. 2 illustrates a flowchart illustrating task assignment in a cloud system 100 according to an embodiment of the present disclosure, and FIG. 3 illustrates a process of notifying a control server 120 of an acceleration function list 50 of the function accelerator cards 112a and 112b in the cloud system 100 for this purpose.

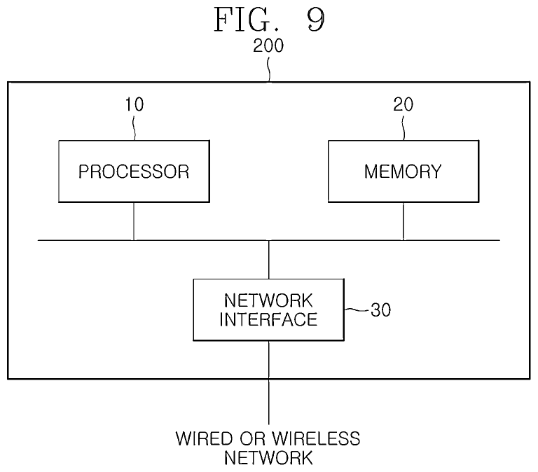

The method illustrated in FIG. 2 may be performed, for example, by the control server 120, and furthermore, the control server 120 may be implemented to include a computing device in FIG. 9 and the following description related to FIG. 9. For example, the control server 120 may include a processor 10, and the processor 10 may perform the task assignment by executing instructions configured to implement operations for performing the task assignment.

More specifically, as illustrated in FIGS. 2 and 3, a method for task assignment in a cloud system 110, according to an embodiment of the present disclosure, may be performed through the steps of: receiving, from function accelerator cards 112a and 112b included in one or more unit task servers 111a and 111b of the cloud system 100, a list of acceleration functions that can be performed by the function accelerator cards 112a and 112b (S110); and assigning a first task to the function accelerator cards 112a and 112b in consideration of the acceleration function list (S120).

The function accelerator cards 112a and 112b and the unit task servers 111a and 111b may each be configured as separate task nodes in the cloud system 100.

The function accelerator cards 112a and 112b may be assign second identification information distinct from first identification information of the unit task servers 111a and 111b, and the control server 120 may receive the acceleration function list from the function accelerator cards 112a and 112b by using the second identification information.

The acceleration function list may be generated using agents 1122 installed and driven in the function accelerator cards 112a and 112b and transmitted to the control server 120.

The agents 1122 may generate available resource information regarding the status of available resources of the function accelerator cards 112a and 112b and transmit the available resource information to the control server 120.

The agents 1122 may generate state information regarding operation states of the function accelerator cards 112a and 112b at predetermined intervals and transmit the state information to the control server 120.

The control server 120 may update the states of the function accelerator cards 112a, and 112b based on the state information periodically transmitted from the agents 1122, and may assign tasks to the function accelerator cards 112a, and 112b in consideration of the states of the function accelerator cards 112a, and 112b.

The control server 120 may produce, based on predetermined criteria, a second task corresponding to the first task and assign the second task to the unit task servers 111a and 111b including the function accelerator cards 112a and 112b.

The control server 120 may produce the second task based on network traffic generated between the first task and the second task, and assign the second task to the unit task servers 111a and 111b.

A part of the first task assigned to the function accelerator cards 112a and 112b may be migrated to and processed by the unit task servers 111a and 111b including the function accelerator cards 112a and 112b.

When the performance of the first task does not meet predetermined target performance, a part of the first task may be migrated to and processed by the unit task servers 111a and 111b.

Accordingly, in the method, the apparatus, the system, and the computer program for notifying functions of the function accelerator cards 112a and 112b included in the cloud system 100 according to an embodiment of the present disclosure, it is possible to efficiently use multiple acceleration functions of function accelerator cards 112a and 112b included in the unit task servers 111a and 111b of the cloud system 100. Furthermore, it is possible to solve the problem of reducing the task efficiency of the unit task servers 111a and 111b and the function accelerator cards 112a and 112b by redistributing task load to the function accelerator cards 112a and 112b through the unit task servers 111a and 111b in order to assign the task load to the function accelerator cards 112a and 112b.

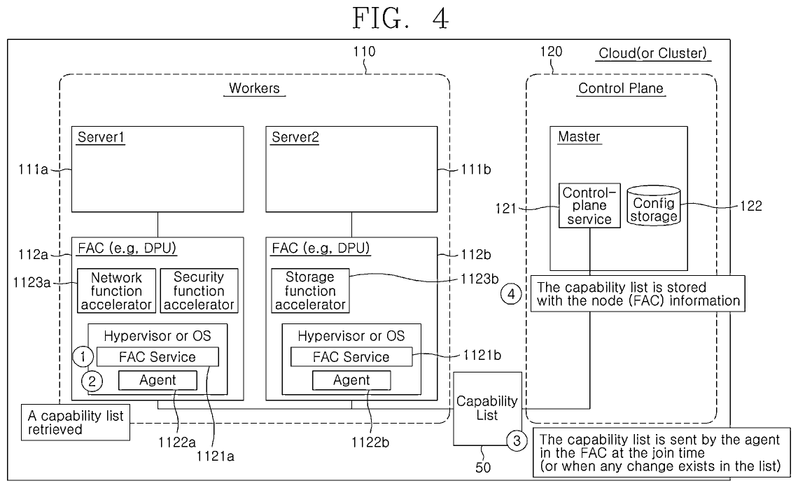

Furthermore, FIG. 4 illustrates a process of notification of an acceleration function list 50 and task assignment based on the list in the cloud system 100 according to an embodiment of the present disclosure.

Hereinafter, the process of task assignment in the cloud system 100 according to an embodiment of the present disclosure will be described in more detail with reference to FIGS. 2 to 4.

As illustrated in FIG. 4, a first function accelerator card (FAC) (112a) included in the first unit task server 111a may have a hardware driver for the first function accelerator card (112a) installed on a hypervisor or an operating system (OS), and then a first FAC service 1121a driven in the hypervisor or operating system (OS) of the first function accelerator card 112a may disclose and provide information about the acceleration functions included in the first function accelerator card 112a in a predetermined manner such as an API or an SDK (\textcircled{1} in FIG. 4).

Accordingly, a first agent 1122a driven in the first function accelerator card 112a may extract a list of acceleration functions (e.g., 1123a in FIG. 4, a network function accelerator and a security function accelerator) included in the first function accelerator card 112a (\textcircled{2} in FIG. 4). In this case, the first agent 1122a may be a type of daemon that is installed on each node in a distributed environment, and performs management processes such as task assignment through communication with a control-plane service 121 of the control server 120 that functions as a master node.

As a more specific example, the first FAC service 1121a may be implemented as a service (e.g., a DaemonSet in Kubernetes, etc.) operating in each node as a system service. The service may use a dedicated library (e.g., DOCA at NVIDIA, etc.) performed in a core (e.g., an ARM core, etc.) of the first function accelerator card 112a to extract the acceleration function list (Capability List) 50 available in the first function accelerator card 112a, and may provide the extracted list 50 to the control server 120 via the first agent (e.g., kubelet in Kubernetes, etc.) 1122a.

Subsequently, the first agent 1122a may transmit the extracted acceleration function list 50 to the control server 120 functioning as the master node at the time of or after joining a cluster (e.g., kubeadm join) (\textcircled{3} in FIG. 4).

The first function accelerator card 112a may be assigned second identification information (e.g., IP address (12.34.56.78) or ID (fac001) that is distinct from first identification information (e.g., IP address (12.34.56.79) or ID (fac002)) of the first unit task server 111a. Thus, the control server 120 may use the second identification information to receive the acceleration function list 50 from the first function accelerator card 112a, and may identify and use the acceleration function list 50 corresponding to the first function accelerator card 112a.

More specifically, the first function accelerator card 112a may implement processing rules on a pipe-by-pipe basis in a hardware accelerator (HW accelerator) for processing of a series of packets (packet processing), so that multiple pipes are connected and operated. In this case, the packets may be processed based on rules defined for each pipe and corresponding actions.

Accordingly, the first function accelerator card 112a may identify a destination IP of a packet in a pipe, and when there is a corresponding target (e.g., the first unit task server 111a), the packet may be forwarded to the corresponding target, and when no corresponding target is identified, the packet may be identified and processed as a packet sent to the first function accelerator card 112a by default.

Accordingly, the control server 120 may directly transmit messages, data, etc., which is to be transmitted to the first function accelerator card 112a, to the first function accelerator card 112a without going through the first unit task server 111a.

Furthermore, the first function accelerator card 112a may be configured as a separate task node operating independently of the first unit task server 111a in the cloud system 100.

As a more specific example, in the case of Kubernetes, data may be transmitted, through a REST method, to an API server such as the control-plane service 121 of the control server 120 which functions as a master node.

In addition, when there is an endpoint (e.g., /api/v1/nodes/$NAME/capabilities, etc.), the acceleration function list (Capability List) 50 may be transmitted to the endpoint together with an authorization token by using a PUT HTTP request.

Furthermore, more specifically, the control-plane service 121 may receive, from the first function accelerator card 112a, information such as the upper limit and usage status of resources such as CPU and memory, the state of the first function accelerator card 112a, the state of a running workload (e.g., a pod), the acceleration function list (Capability List) and each state, and the like.

In addition, the control-plane service 121 may receive, from the first unit task server 111a, information such as the upper limit and usage status of resources such as CPU and memory, the state of the first unit task server 111a, and the status of a running workload (e.g., a pod).

Accordingly, the first function accelerator card 112a may be assigned a task directly from the control server 120 without going through the first unit task server 111a and process the task.

Furthermore, the control-plane service 121 of the control server 120 may store the acceleration function list 50 of the first function accelerator card 112a in a configuration storage 122 and manage the acceleration function list 50 (\textcircled{4} in FIG. 4). In this case, the control-plane service 121 of the first function accelerator card 112a may receive, together with the acceleration function list 50 of the first function accelerator card 112a, identification information (e.g., ID, IP address, etc.) of the first function accelerator card 112a and available resource information such as the status, operation state, etc. of available resources such as CPU of the first function accelerator card 112a, and may store the identification information and the available resource information in the configuration storage 122.

In addition, in the configuration storage 122, identification information and available resource information, such as the status, operation state, etc. of available resources, such as a CPU, of the second function accelerator card 112b may be stored together with the acceleration function list 50 of the second function accelerator card 112b. Furthermore, identification information of the first unit task server 111a and the second unit task server 111b, and available resource information such as the status, operation state, etc. of available resources such as CPUs thereof may also be stored.

Accordingly, the control server 120 may select a task to be assigned to the first function accelerator card 112a in consideration of the acceleration function list 50 of the first function accelerator card 112a stored in the configuration storage 122, and may also select a task to be assigned to the first function accelerator card 112a in consideration of additional information about the first function accelerator card 112a and information about another function accelerator card 112b and the unit task servers 111a and 111b, stored in the setting storage part 122.

Furthermore, the control server 120 may produce, based on predetermined criteria, a second task corresponding to a first task assigned to the first function accelerator card 112a, and assign the second task to the first unit task server 111a including the first function accelerator card 112a.

More specifically, the control server 120 may produce the second task based on network traffic generated between the first task and the second task and assign the second task to the first unit task server 111a. In this case, the first function accelerator card 112a may be installed in a slot or the like of the first unit task server 111a and operated while transmitting data at a high speed via a data bus or the like, so that it possible to efficiently perform the first task and the second task while processing the network traffic generated between the first task and the second task at a high speed.

Furthermore, in an embodiment of the present disclosure, it is possible to migrate a part of the first task assigned to the first function accelerator card 112a to the first unit task server 111a including the first function accelerator card 112a for processing.

More specifically, when the performance of the first task being executed by the first function accelerator card 112a does not meet predetermined target performance, a part of the first task may be migrated to and processed by the first unit task server 111a, thereby enabling the first task to be efficiently performed. To this end, it is preferable to consider the available resource information such as the status, operation state, etc. of the available resources such as a CPU of the first unit task server 111a together.

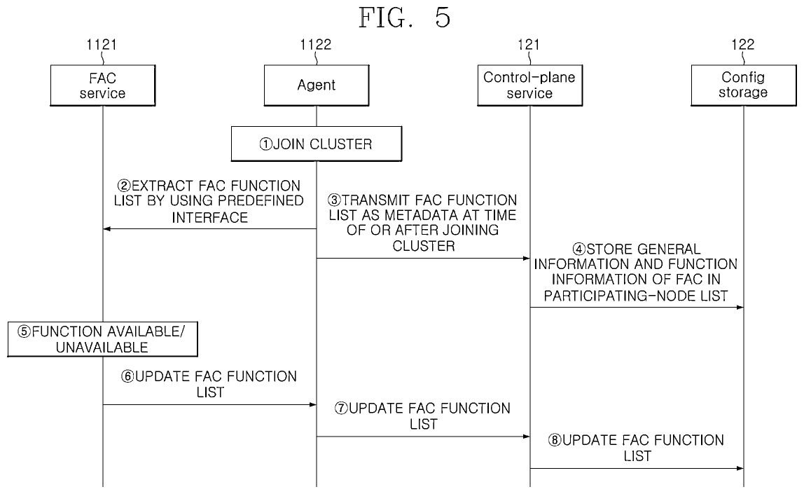

FIG. 5 is a flowchart illustrating notification of an acceleration function list of a function accelerator card 112 in a cloud system 100 according to an embodiment of the present disclosure.

As illustrated in FIG. 5, an agent 1122 of the function accelerator card 112 included in a unit task server 111 may extract (\textcircled{2} in FIG. 5) an acceleration function list 50 of the function accelerator card 112 from an FAC service 1121 driven in the function accelerator card 112 via a predefined interface such as an API or SDK at the time of joining a cluster (e.g., kubeadm join) (\textcircled{1} in FIG. 5).

Subsequently, the agent 1122 may transmit the extracted acceleration function list 50 as metadata to a control-plane service 121 driven in the control server 120 at the time of or after joining a cluster (\textcircled{3} in FIG. 5).

Accordingly, the control-plane service 121 may provide the acceleration function list 50 to a configuration storage 122 to store, in a list of participating nodes of the cluster, information including the acceleration function list 50 of the function accelerator card 112 (\textcircled{4} in FIG. 5).

Subsequently, if some or all of the acceleration functions of the function accelerator card 112 change to an unavailable state, or change from an unavailable state to an available state again (\textcircled{5} in FIG. 5), the function accelerator card 112 may update and provide the acceleration function list 50 (\textcircled{6} in FIG. 5), and the agent 1122 may collect the updated acceleration function list 50 and provide the collected acceleration function list 50 to the control-plane service 121 (\textcircled{7} in FIG. 5).

Accordingly, the control-plane service 121 may store the updated acceleration function list 50 in the configuration storage 122 (\textcircled{8} in FIG. 5), and may select a task to be assigned to the function accelerator card 112 in light of the acceleration function list 50.

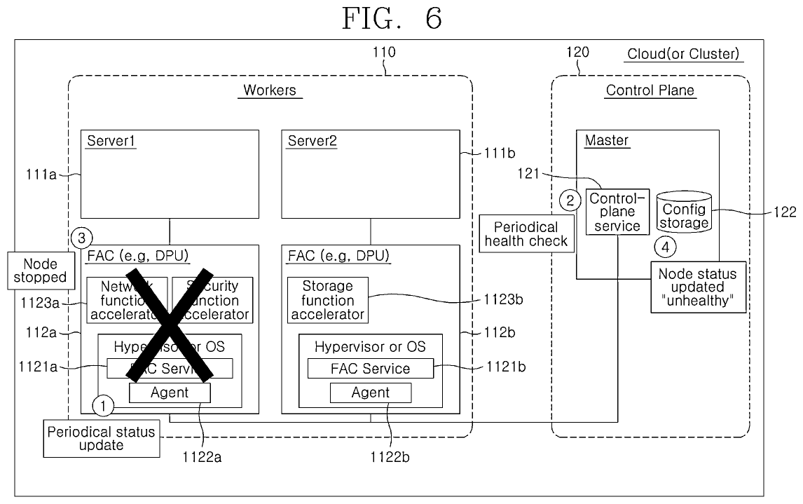

FIG. 6 illustrates a process of updating the operation state of a function accelerator card 112 in a cloud system 100 according to an embodiment of the present disclosure.

As illustrated in FIG. 6, a first agent 1122a of the first function accelerator card (FAC) 112a may generate state information such as the normal or abnormal operation of the first function accelerator card 112a at predetermined intervals and periodically transmit the generated information to a control server 120 functioning as a master node (\textcircled{1} in FIG. 6). Accordingly, a control-plane service 121 of the control server 120 may check the normal or abnormal operation of the first function accelerator card 112a based on the periodically transmitted state information (\textcircled{2} of FIG. 6).

However, when the first function accelerator card (FAC) 112a stops operation due to an abnormal cause or the like, the transmission of the state information periodically transmitted by the first agent 1122a may also be interrupted (\textcircled{3} of FIG. 6).

In this case, the control server 120 may determine that the state of the first function accelerator card 112a is an abnormal state (unhealthy in FIG. 6) and change the state of the first function accelerator card 112a.

Accordingly, even when there is a request to assign a task to the first function accelerator card 112a, the control server 120 may withhold assigning the task to the first function accelerator card 112a, until the state information of the first function accelerator card 112a is updated again and the state of the first function accelerator card 112a switches to a normal state.

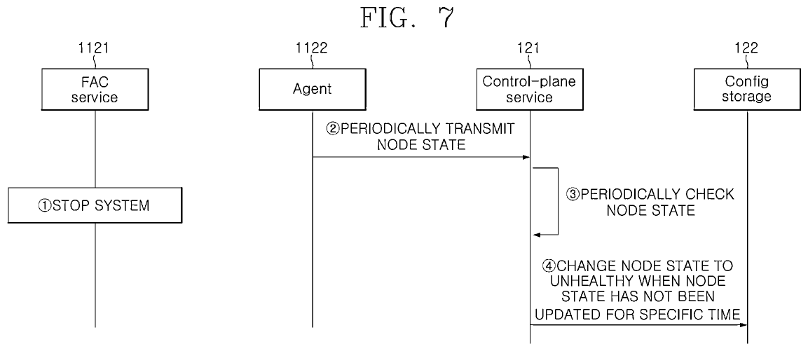

FIG. 7 is a flowchart illustrating updating the operation state of a function accelerator card 112 in a cloud system 100 according to an embodiment of the present disclosure.

As illustrated in FIG. 7, an agent 1122 of the function accelerator card 112 may generate state information such as the normal or abnormal operation of the function accelerator card 112 at predetermined intervals and periodically transmit the generated information to a control server 120 that functions as a master node (\textcircled{2} of FIG. 7). In this case, when the operation of the function accelerator card 112 is stopped due to an abnormal cause or the like (\textcircled{1} of FIG. 7), the transmission of the state information periodically transmitted by the agent 1122 may also be stopped.

In this case, the control-plane service 121 of the control server 120 may check the normal or abnormal operation of the function accelerator card 112 based on the periodically transmitted state information (\textcircled{3} in FIG. 7). When the transmission of the state information transmitted from the agent 1122 is not updated for a certain predetermined time, the state of the function accelerator card 112 may be changed to an abnormal (unhealthy) state and stored in the configuration storage 122 (\textcircled{4} in FIG. 7).

Accordingly, the control-plane service 121 may reflect the state of the function accelerator card 112 to determine whether to assign a task to the function accelerator card 112.

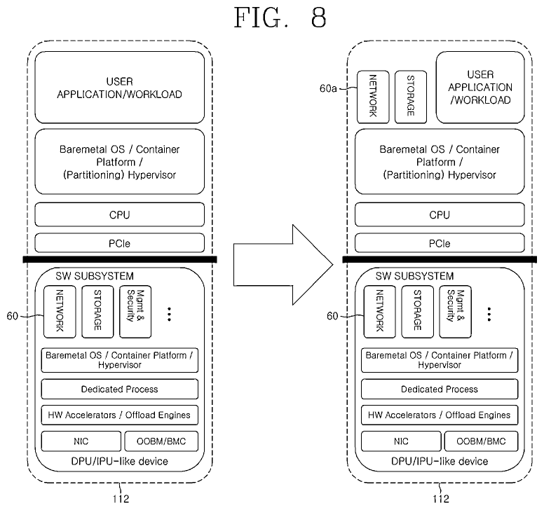

FIG. 8 illustrates task allocation from a function accelerator card 112 to a unit task server in a cloud system 100 according to an embodiment of the present disclosure.

As illustrated in FIG. 8, the present disclosure may allow a part 60a of a first task 60 assigned to the function accelerator card 112 to be migrated to and processed by a unit task server 111 including the function accelerator card 112.

As a more specific example, when the performance of the first task 60 processed by the function accelerator card 112 does not meet predetermined target performance, a part 60a of the first task 60 may be migrated to and processed by the unit task server 111, thereby enabling more efficient processing of the first task 60.

In this case, whether to migrate a part 60a of the first task 60 to the unit task server 111 for processing may be determined by comparing performance (e.g., the time taken for task completion) when the function accelerator card 112 continues to perform the first task 60 with performance when the part 60a of the first task is processed by the unit task server 111. In addition, it is possible to consider available resource information such as the status, operation state, etc. of available resources such as a CPU of the unit task server 111.

Furthermore, a computer program according to another aspect of the present disclosure is a computer program stored in a computer-readable medium in order to execute in a computer a series of steps of a method for function notification of and task allocation to the function accelerator card 112 in the cloud system 100 described above. The computer program may be not only a computer program including machine language code generated by a compiler, but also a computer program including high-level language code that can be executed on a computer by using an interpreter or the like. In this case, the computer is not limited to a personal computer (PC) or a notebook computer, but includes any information processing device, such as a server, smartphone, tablet PC, PDA, or mobile phone, which has a central processing unit (CPU) and is capable of executing a computer program.

Furthermore, the computer-readable medium may be a medium for continuously storing a computer-executable program, or for temporarily storing the computer-executable program for execution or download. Furthermore, the medium may be any of various recording or storage means in the form of a single or multiple combined pieces of hardware, and is not be limited to a medium directly connected to a computer system, but may be distributed over a network. Accordingly, the above detailed description is not to be construed as exemplary and not restrictive in all aspects. The scope of the present disclosure should be determined by a reasonable interpretation of the appended claims, and all modifications within the equivalent scope of the present disclosure are included in the scope of the present disclosure.

Furthermore, FIG. 9 illustrates an apparatus 200 to which the method proposed by the present disclosure is applicable.

Referring to FIG. 9, the apparatus 200 may be configured to implement the process of function notification of and task assignment to a function accelerator card 122 in a cloud system 110 according to the method proposed by the present disclosure. In an example, the apparatus 200 may be a control server 120 for controlling one or more unit task servers 111a and 111b and one or more function accelerator cards 112a and 112b that constitute the cloud system 100.

For example, the apparatus 200 to which the method proposed by the present disclosure is applicable may include a network device such as a repeater, a hub, a bridge, a switch, a router, or a gateway, a computer device such as a desktop computer or a workstation, a mobile terminal such as a smartphone, a portable device such as a laptop computer, home appliances device such as a digital television, a transportation means such as an automobile, etc. In another example, the apparatus 200 to which the present disclosure is applicable may be included as a part of an application specific integrated circuit (ASIC) implemented in the form of system-on-chip (SoC).

A memory 20 may be operatively coupled to a processor 10, may store programs and/or instructions for processing and control of the processor 10, and may store data and information used in the present disclosure, control information required for processing the data and information according to the present disclosure, temporary data generated during the processing of the data and information, and the like. The memory 20 may be implemented as a storage device such as read only memory (ROM), random access memory (RAM), erasable programmable read only memory (EPROM), electrically erasable programmable read-only memory (EEPROM), flash memory, static RAM (SRAM), hard disk drive (HDD), solid state drive (SSD), etc.

The processor 10 may be operatively connected to the memory 20 and/or a network interface 30, and controls the operation of each module in the apparatus 200. In particular, the processor 10 may perform various control functions for performing the method proposed by the present disclosure. The processor 10 may also be referred to as a controller, a microcontroller, a microprocessor, a microcomputer, etc. The method proposed by the present disclosure may be implemented by hardware, firmware, software, or a combination thereof. When the present disclosure is implemented using hardware, the processor 10 may include an application specific integrated circuit (ASIC), a digital signal processor (DSP), a digital signal processing device (DSPD), a programmable logic device (PLD), a field programmable gate array (FPGA), etc. configured to perform the present disclosure. Meanwhile, when firmware or software is used to implement the method proposed by the present disclosure, the firmware or the software may include instructions related to modules, procedures, or functions for performing functions or operations necessary for implementing the method proposed by the present disclosure. The instructions may be stored in memory 20 or in a computer-readable recording medium (not shown) separate from memory 20 and configured to cause, when executed by the processor 10, the apparatus 200 to implement the method proposed by the present disclosure.

Furthermore, the apparatus 200 may include the network interface device 30. The network interface device 30 may be operatively connected to the processor 10, and the processor 10 may control the network interface device 30 to transmit or receive wireless/wired signals carrying information and/or data, signals, messages, etc. over wireless/wired networks. The network interface device 30 may support various communication standards, such as IEEE 802 series, 3GPP LTE (-A), and 3GPP 5G, and may transmit or receive control information and/or data signals based on the communication standards. The network interface device 30 may be implemented outside the apparatus 200 as needed.

Accordingly, the method, the apparatus, the system, and the computer program for function notification of function accelerator cards included in a cloud system, according to an embodiment of the present disclosure, enables efficient utilization of multiple acceleration functions of each function accelerator card 112 included in the unit task server 111 of the cloud system 100.

Furthermore, the method, the apparatus, the system, and the computer program for function notification of function accelerator cards included in a cloud system, according to an embodiment of the present disclosure, may solve the problem in which, in order to assig a task load to each function accelerator card 112, the task load is redistributed to each function accelerator card 112 through each unit task server 111, thereby reducing the task efficiency of the unit task server 111 and the function accelerator card 112.

The above embodiments and the drawings described in the specification are merely exemplary, and do not limit the scope of the present disclosure in any way. Furthermore, the connections or connection members of lines between the elements illustrated in the drawings are illustrative of functional connections and/or physical or circuit connections, which may be represented by various alterative or additional functional connections, physical connections, or circuit connections in actual devices. Furthermore, the elements may not necessary for the application of the present disclosure unless specifically mentioned as “essential”, “important”, etc.

In the specification of the present disclosure (particularly in the claims), the term “said” and similar indicative terms may be used in both the singular and the plural. Furthermore, mentioning a range in the present disclosure is deemed as including the disclosure to which individual values falling within the range is applied (unless mentioned otherwise), and is equivalent to mentioning each individual value constituting the range in the detailed description of the disclosure. Furthermore, the steps presented in the method invention of the present disclosure are not necessarily intended to be binding in terms of the sequential order thereof, and the order may be appropriately modified as needed, unless the nature of the process requires that one step necessarily precede another. All examples or illustrative terms (e.g., etc.) in the present disclosure are merely used to describe the present disclosure in detail, and unless limited by the claims, the scope of the disclosure is not limited by the examples or illustrative terms. Furthermore, those skilled in the art will understand that various modifications, combinations, and changes may be made depending on design conditions and elements within the appended claims or equivalents thereof.

What is claimed is:

1. A method performed by a control server of a cloud system, the method comprising:
receiving, from a function accelerator card included in at least one unit task server of the cloud system, a list of acceleration functions that are capable of being performed by the function accelerator card; and
assigning a first task to the function accelerator card in consideration of the acceleration function list.

2. The method of claim 1, wherein each of the function accelerator card and the unit task server is configured to serve as a separate task node in the cloud system.

3. The method of claim 1, wherein the function accelerator card is configured to be assigned second identification information distinct from first identification information of the unit task server, and
the control server is configured to receive the acceleration function list from the function accelerator card by using the second identification information.

4. The method of claim 1, wherein the acceleration function list is generated using an agent installed and driven in the function accelerator card, and is transmitted to the control server.

5. The method of claim 4, wherein the agent is configured to generate available resource information regarding a status of available resources of the function accelerator card and transmit the available resource information to the control server.

6. The method of claim 4, wherein the agent is configured to generate state information regarding an operation state of the function accelerator card at predetermined periods and transmit the state information to the control server.

7. The method of claim 6, wherein the control server is configured to:
update the state of the function accelerator card, based on the state information periodically transmitted from the agent; and
assign a task to the function accelerator card in consideration of the state of the function accelerator card.

8. The method of claim 1, wherein the control server is configured to produce a second task corresponding to the first task, based on predetermined criteria, and assign the second task to the unit task server in which the function accelerator card is included.

9. The method of claim 8, wherein the control server is configured to produce the second task, based on network traffic generated between the first task and the second task, and assign the second task to the unit task server.

10. The method of claim 1, wherein a part of the first task assigned to the function accelerator card is migrated to and processed by the unit task server in which the function accelerator card is included.

11. The method of claim 10, wherein in case that performance of the first task does not meet predetermined target performance, a part of the first task is migrated to and processed by the unit task server.

12. A control server of a cloud system, the control server comprising: a processor; and a memory,
wherein the memory comprises instructions which, when executed by the processor, cause the server to implement specific operations,
wherein the specific operations comprise:
receiving, from a function accelerator card included in at least one unit task server of the cloud system, a list of acceleration functions that are capable of being performed by the function accelerator card; and
assigning a first task to the function accelerator card in consideration of the acceleration function list.

13. The control server of claim 12, wherein each of the function accelerator card and the unit task server is configured to serve as a separate task node in the cloud system.

14. The control server of claim 12, wherein the function accelerator card is configured to be assigned second identification information distinct from first identification information of the unit task server, and
the control server is configured to receive the acceleration function list from the function accelerator card by using the second identification information.

15. The control server of claim 12, wherein the control server is configured to produce a second task corresponding to the first task, based on predetermined criteria, and assign the second task to the unit task server in which the function accelerator card is included.

16. A computer-readable storage medium storing instructions which, when executed by a processor included in a control server of a cloud system, cause the control server to implement specific operations, wherein the specific operations comprise:
receiving, from a function accelerator card included in at least one unit task server of the cloud system, a list of acceleration functions that are capable of being performed by the function accelerator card; and
assigning a first task to the function accelerator card in consideration of the acceleration function list.
